(19) United States
(12) Patent Application Publication
(10) Pub. No.: US 2015/0377437 A1
(43) Pub. Date: Dec. 31, 2015

(54) LIGHT SOURCE AND METHOD FOR PRODUCING THE LIGHT SOURCE

(71) Applicant: CONTINENTAL AUTOMOTIVE GMBH, Hannover (DE)

(72) Inventors: MAXIMILIAN AUSTERER, WIEN (AT); WOLFGANG KOELLNER, WIEN (AT)

(21) Appl. No.: 14/767,666

(22) PCT Filed: Feb. 3, 2014
(86) PCT No.: PCT/EP2014/052058

§ 371 Date: Aug. 13, 2015

(30) Foreign Application Priority Data
Feb. 13, 2013 (DE) 10 2013 202 282.4

(51) Int. Cl. F21S 8/10; B60Q 1/00; F21V 29/70; F21V 23/00; F21V 29/89

(52) U.S. Cl. CPC F21S 48/115; F21V 23/005; F21V 29/89; F21V 29/70; B60Q 1/0088

(57) ABSTRACT

A light source and a method for producing the light source, for integration in a headlight. The assembly has a circuit board, on which at least one light diode and a converter unit for supplying power to the LED are arranged. The converter unit and the at least one LED are surface-mounted components (surface-mounted device, SMD) and the converter unit has one or a plurality of buck converters.

The invention relates to a light source for integration in a headlamp comprising a printed circuit board, on which at least one light-emitting diode (LED) and a converter unit for supplying power to the LED are arranged, and to a method for producing such a light source.

Such light sources are finding increasing numbers of applications in particular in the motor vehicle sector in headlamps for main beam or indicator light functions and are typically combined with optical elements such as reflectors, projectors and fiberoptic conductors.

A conventional LED headlamp used in practice has, for example, one or more LED modules and, in order to supply a constant current to the LEDs, one or more offset electronic ballasts. The connection of the LED modules to the ballasts is performed by means of a plug-type and cable connection. Since pulse-width-modulated signals are used for actuating the LEDs, the lines required for this emit radiation in a range which can result in interference in the case of electrical or electronic devices in the surrounding environment. This problem is generally combated with the aid of output filters in the control device, but this results in limitations in the case of low duty factors since said duty factors are downwardly limited by the filter elements. In addition, the use of boost and buck converters which is required in offset control devices results in poor efficiency of the control device and requires a correspondingly large heat sink. An LED headlamp therefore places more stringent requirements on the internal cable harness and in addition requires a greater amount of installation space than conventional halogen headlamps, for example.

The integration of a converter unit and at least one LED on a common printed circuit board has the advantage that no dedicated control device which is offset from an LED module needs to be used, and this therefore simplifies the application, i.e. both the design of the headlamp and the fitting of the light source, and reduces or avoids outgoing electromagnetic radiation. For example, light sources are known which consist of completely closed-off, standardized modules and provide a defined thermal, electrical and optical interface on the outside. In this case, a disadvantageous restriction of the design freedom as regards optical and thermal properties is accepted in order to achieve a maximum degree of replaceability and standardization.

In the known light sources, four or more LEDs are connected in series and are supplied by a common voltage converter, for example a SEPIC (single-ended primary inductance converter), which steps up or steps down the available vehicle electrical distribution system voltage correspondingly; in this case, the LEDs are embodied as chip-on-board modules. Both measures reduce the production costs of the standardized light source, but in particular the voltage converter for step-up conversion requires relatively complex or voluminous cooling owing to the poor energy efficiency.

In contrast, the object of the invention consists in providing a more compact light source which additionally permits variable placement of LEDs.

This object is achieved in the case of a light source of the type mentioned at the outset by virtue of the fact that the converter unit and the at least one LED are in the form of surface-mounted components (surface-mounted devices, SMD), wherein the converter unit has one or more step-down converters. In particular, all of the converter circuits of the converter unit are step-down converters. Such a light source is characterized by particularly low heat losses in the voltage conversion since purely step-down converters have a higher electrical efficiency than any other type of switching controllers. Therefore, more simple and more compact cooling can be used. In addition, the light source can be matched flexibly to different requirements owing to the LEDs provided as SMD component parts and converter units during production without any changes to the printed circuit board. For example, population with LEDs can be reduced in comparison with full population of the printed circuit board and/or the populated positions can be selected appropriately. Overall, a substantially more flexible and more compact and therefore even more easily integratable and universally useable light source therefore results, which has a low overall weight and whose installation is associated with minimum wiring complexity. By virtue of the partitioning of the system functions, in addition as far as possible reuse of the components in different applications and therefore scale effects are achieved.

The LED configuration should advantageously be selected such that each LED has a supply voltage which is equal to or less than a supply voltage of the converter unit. In the case of a typical vehicle electrical distribution system voltage of from 6 to 18 V, this can mean that at most two LEDs are connected in series. A further advantage of such a circuit consists in that failure of a single LED can be diagnosed easily and reliably with the aid of a measurement of the LED string voltage.

Therefore, preferably only step-down converters, but not step-up converters, are therefore provided as the actual converter.

If a greater number of LEDs is required, it is favorable if the converter unit has a plurality of step-down converters and is in the form of an integration set (system-in-package, SiP). By virtue of integration in an SiP, the space requirement can be kept relatively low in comparison with separate voltage converters and nevertheless a plurality of highly efficient converters can be designed for supplying power to the LEDs.

In order to avoid the need for an inefficient step-up converter when using more than two LEDs, it is furthermore advantageous if a parallel circuit comprising a plurality of LEDs is arranged on the printed circuit board and is connected to the converter unit. Owing to the parallel circuit, an addition of the LED forward voltages is prevented and it is also possible for only (at least) one step-down converter to be provided for supplying power to a plurality of LEDs from a vehicle electrical distribution system voltage.

In order to cool the LEDs and the converter unit, it is further advantageous if the printed circuit board is a thermal substrate, preferably a metal-core printed circuit board, in particular with an aluminum or copper core. By virtue of the special printed circuit board, heat is spread directly at the LEDs and, as a result, the LED junction temperature is kept low.

If a cooling device, preferably a cooling plate or a die-cast body, is connected, in particular welded, to the printed circuit board on a side opposite the LED, improved dissipation of the power losses generated of the LEDs and the converter unit can be achieved. Owing to the relatively high efficiency of the voltage converter (step-down converter) used, the cooling device can generally be more compact than in the case of known light sources.

It is advantageous for optimum heat distribution if the cooling device consists of the same material as a metal core of the printed circuit board. In addition, any mechanical stresses between the printed circuit board and the cooling device can thus be reduced and the connection of the two parts, for example by means of welding, is simplified.

It has proven to be particularly advantageous if the converter unit has an interface for the transmission of diagnostic and/or control data, which is preferably in the form of a single-wire interface, in particular in the form of a local interconnect network (LIN) interface. A central monitoring and/or control device can be connected to the light source via such an interface so that any malfunctions can be communicated to other systems, for example, and control of the light source is made possible without manipulation of the supply voltage.

A further improvement in comparison with the prior art can be achieved if, together with the converter unit and the at least one LED, a binning coding element, in particular a binning coding resistor, is arranged on the printed circuit board. “Binning” is understood to mean in this context a class division of the LEDs used depending on the luminous efficacy and tone thereof. When the binning of the LEDs used is known, a uniform luminous color can be achieved in the case of differently classified LEDs by corresponding matching of the supply current. In the case of an arrangement on the printed circuit board, the binning coding element does not need to be read externally via an additional line, for example a power supply interface, as has been conventional until now in the prior art, but can set the current assigned to a binning, i.e. a class division of the LEDs, directly, i.e. locally on the printed circuit board. The integration of the binning coding element is made possible by virtue of the fact that the binning of the placed LEDs is known during manufacture and therefore the binning coding element assigned to the respective binning can be selected immediately and likewise placed. The binning coding element may be, for example, a binning coding resistor or a logic module programmed with the respective binning setting. Advantageously, the solution specified here is much more reliable, for example less sensitive to moisture or dirt on the printed circuit board, avoids compatibility problems when purchasing LEDs, and is at the same time less expensive than gauging of a binning coding resistor.

It has furthermore proved to be favorable if a shunt for measuring an LED current is connected in series with at least one LED, preferably between the LED and ground. Owing to the integration of LEDs and converter unit on only one printed circuit board, a short-circuit strength of the LED driver, i.e. of the converter unit, with respect to a short circuit to ground or with respect to the supply voltage is not required. A shunt for current measurement can therefore be arranged upstream (“highside”) and downstream (“lowside”) of an LED string in relation to the voltage. In this case, the downstream arrangement, namely between the LEDs and ground, has the advantage of a much lower level of complexity in terms of circuitry for the current measurement, with the result that costs for the light source can be reduced.

The method of the type mentioned at the outset achieves the abovementioned object by virtue of the fact that, in the case of the production of light sources of the abovementioned type, in the case of an otherwise identical design of the light source, the number and position of the LEDs connected to the printed circuit board are configured. Using the in each case present configuration, therefore, a range of differently populated printed circuit boards can be produced, as a result of which the flexibility of the present light source in terms of the optical and thermal properties is considerably increased in comparison with a completely standardized light source.

In this context, it has proven to be particularly favorable if at least one LED is connected to the printed circuit board by reflow soldering. Reflow soldering enables a simple, quick and reliable connection and can at the same time be modified easily corresponding to a configured placement scheme by virtue of any superfluous soldering points being omitted or not being provided with the solder.

The invention will be explained in further detail below with reference to particularly preferred exemplary embodiments, to which the invention is not intended to be restricted, however, and with reference to the drawings, in which, specifically:

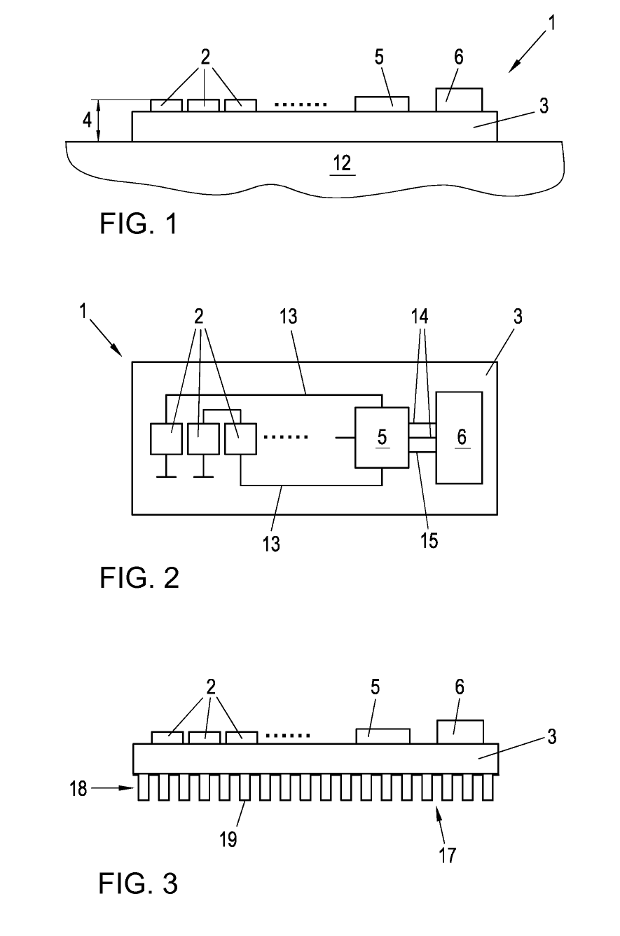

FIG. 1 shows a side view of a compact light source having a step-down converter;

FIG. 2 shows a plan view of the light source shown in FIG. 1;

FIG. 3 shows a side view of a compact light source having a cooling device;

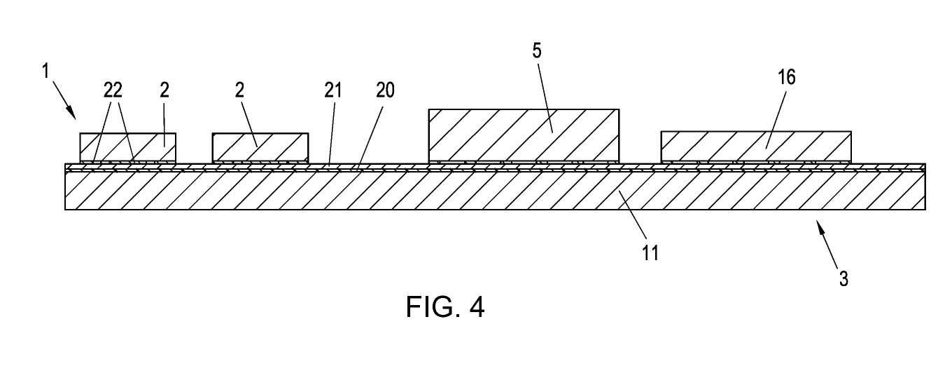

FIG. 4 shows a sectional view through a compact light source;

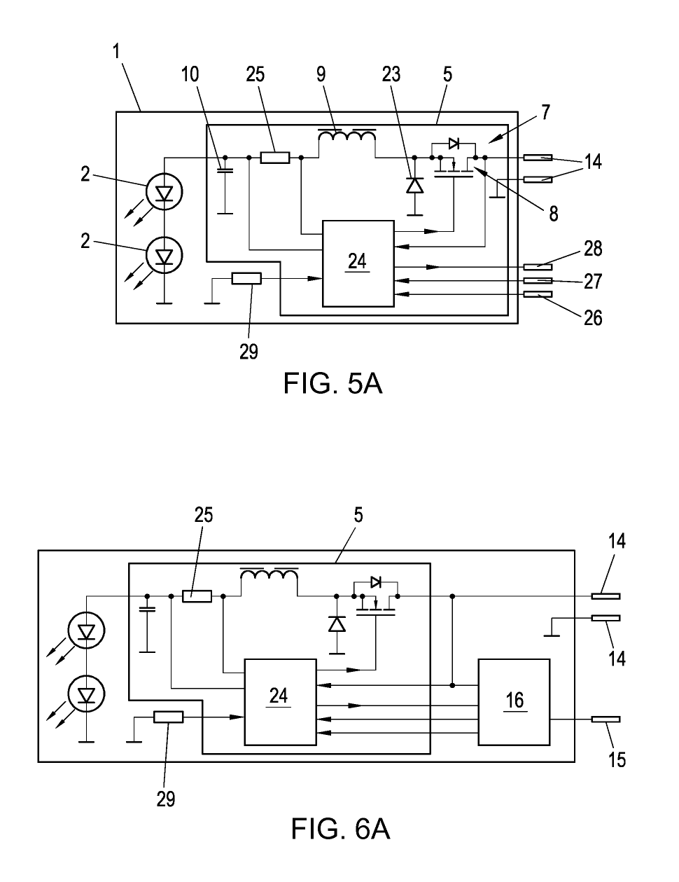

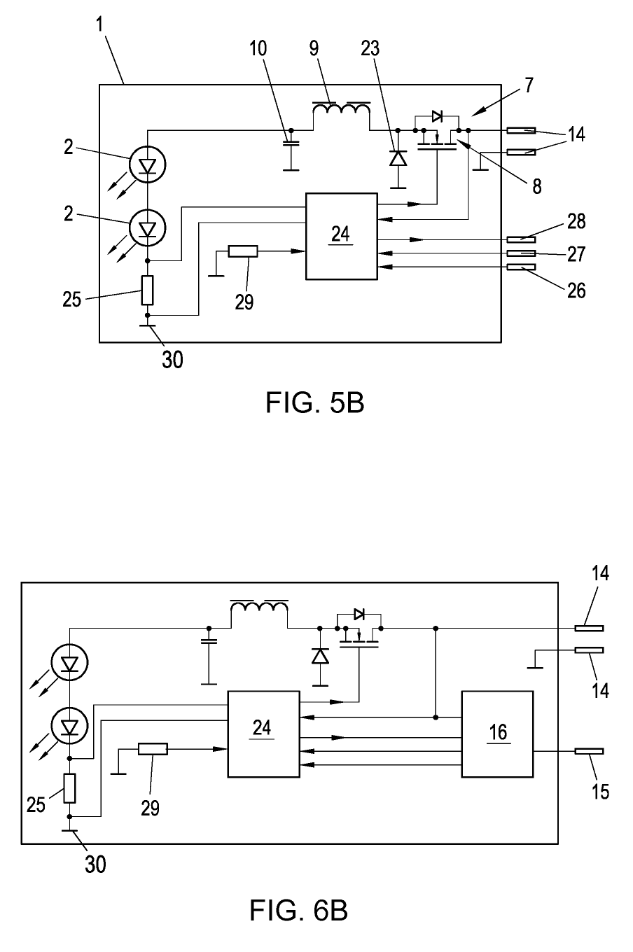

FIG. 5a shows a schematic block circuit diagram of a compact light source having a single step-down converter;

FIG. 5b shows a variant of the light source shown in FIG. 5a;

FIG. 6a shows a schematic block circuit diagram as shown in FIG. 5a additionally with a logic module; and

FIG. 6b shows a variant of the light source shown in FIG. 6a.

FIG. 1 shows a side view of a light source 1 comprising a plurality of LEDs 2. The LEDs 2 are SMD component parts, which are arranged on a printed circuit board 3 or are connected to the printed circuit board 3. The installation height 4 of the light source 1 in the region of the LEDs 2 is approximately 4 mm in this example. In addition, the printed circuit board 3 has a converter unit 5, which is likewise placed by means of SMD process, and a connection part 6 for an electrical connection of the light source 1 to a vehicle electrical distribution system or a headlamp cable harness. The converter unit 5 is embodied as an integration set or system-in-package (SiP) and integrates at least one, preferably a plurality of step-down converters 7 (cf. FIG. 5). The step-down converters 7 are designed for voltage conversion from a typical vehicle electrical distribution system range of from 6 to 18 V to an LED forward voltage, with the result that, for example, a constant current can be supplied to (in each case) two series-connected LEDs 2. A current regulation circuit comprising a power MOSFET 8, the required inductances 9 and any capacitances 10 is integrated in a housing in the converter unit 5 embodied as an SiP (cf. FIG. 5). The dimensions of the converter unit 5 are approximately 15×15×15 mm in this example.

In order to cool the component parts 2, 5, in particular the LEDs 2, which are subject to losses, the printed circuit board 3 is in the form of a metal-core printed circuit board (IMS), for example with an aluminum or copper core 11 (cf. FIG. 4), wherein an epoxide printed circuit board with microvias, an iceberg printed circuit board, a ceramic printed circuit board or comparable thermal substrates can also be provided, however. Accordingly, both the LEDs 2 and the converter unit 5 are connected to the printed circuit board 3 not only electrically but also thermally, with the result that dissipation of the heat emitted by the component parts 2, 5 can take place via the printed circuit board 3. In this example, the printed circuit board 3 is arranged on a carrier 12 having a relatively high thermal conductivity, to which carrier the heat can be transferred.

As is shown in FIG. 2, the printed circuit board 3 is rectangular with dimensions of approximately 50×20 mm and therefore more compact than known fully integrated LED light sources (provided with voltage converters on a printed circuit board with the LEDs). The LEDs 2 are connected to the converter unit 5 via conductor tracks 13 on the printed circuit board 3, for example copper conductor tracks, and some of said LEDs are arranged in a parallel circuit, wherein only ever one or two LEDs 2 are connected in series and are connected to the converter unit 5 via parallel lines. As a result, particularly short connection distances are achieved, and emission of the sometimes radiofrequency voltage pulses can be avoided almost completely. Any filtering measures at the output of the voltage converters in the converter unit 5 can therefore be reduced markedly, and therefore even relatively low duty factors can be represented clearly. The supply voltage of all of the LEDs 2 is identical or less than a vehicle electrical distribution system voltage provided at the connection part 6.

In addition to the connections 14 to a vehicle electrical distribution system, the converter unit 5 has an LIN interface 15 (cf. FIG. 6), which is designed for transmitting diagnostic and/or control data via a LIN bus. For connection to the bus, the converter unit 5 can additionally have a programmable logic module 16, which implements the corresponding bus protocol. As a result, for example, LED failures can be communicated to a central control device, and the step-down converters 7 can be configured corresponding to an incoming control signal, with the result that, for example, the luminosity and/or color of the LEDs 2 can be controlled from the central control device on the LIN bus. Instead of the LIN interface 15, however, any desired unidirectional or bidirectional interface can be provided without any substantial limitation of the advantages, wherein single-wire interfaces have the advantage of particularly simple and inexpensive connections.

The variant of the light source 1 shown in FIG. 3 has a cooling device 18 on a side 17 of the printed circuit board 3 which is remote from the LEDs 2. The cooling device 18 is in the form of a cooling plate 19. The cooling plate 19 preferably consists of the same material as the core 11 of the metal-core printed circuit board 3 and is connected thereto, preferably by means of laser welding.

However, it is also possible for heat sinks consisting of other metals or of ceramic to be used. Very efficient heat dissipation from the SMD component parts 2, 5 to the surrounding environment, for example, is achieved by such a cooling device 18. If necessary, in addition forced convection can be achieved with the aid of a fan.

FIG. 4 shows a sectional view of a further variant of the light source 1, which is in principle similar to the light source shown in FIG. 3, but in this case is shown without a cooling device. In particular, in this case the design of the printed circuit board 3 with a metal core 11, preferably consisting of aluminum or copper, an insulation layer 20 applied to the metal core 11 and copper conductor tracks 21 arranged on the insulation layer 20 is shown. For electrical connection purposes, in each case soldering platelets 22 are arranged between the copper conductor tracks 21 and the placed components 2, 5, 16. As can be seen from FIG. 4, the insulation layer 20 is comparatively thin in comparison with the metal core 11, with the result that good thermal conductivity of the printed circuit board 3 and as unimpeded heat transfer as possible from the component parts 2, 5, 16 to the metal core 11 are achieved. FIG. 5a shows a schematic block circuit diagram of a compact light source 1. The light source 1 represented here comprises two LEDs 2 and a converter unit 5 for supplying power to the LEDs 2. The converter unit 5 for its part has a step-down converter 7, which, in a manner known per se, is constructed from a power MOSFET 8, an inductance 9 and a diode 23. In addition, the converter unit 5 is provided with a current controller 24, which, on the basis of a voltage drop across a shunt 25, implements a current measurement and matches the duty factor of the power MOSFET 8 in accordance with a discrepancy between the measured current and a setpoint current. The current controller 24 is connected to the vehicle electrical distribution system or the vehicle electrical distribution system voltage via the connections 14. The setpoint current to be used is supplied to the current controller 24 via a control input 26. In addition, the current controller 24 is connected to a second control input 27, which is used for transmitting a luminosity value of the light source 1. A diagnostics output 28 of the current controller 24 can be used, for example, for transmitting operational characteristic data and/or error signals to a central control device (not shown).

During the regulation of the power MOSFET 8, the current controller 24 also takes into consideration the resistance value of a binning coding resistor 29, which does not belong to the converter unit 5, but is likewise arranged on the printed circuit board 3 and is connected to the current controller 24. The binning coding resistor 29 to be placed is selected depending on the binning of the LEDs 2 during manufacture of the light source 1, with the result that the present light source 1 can be produced with a universally useable converter unit 5 largely irrespective of the binning of the respectively placed LEDs 2.

In the circuit shown in FIG. 5b, the shunt 25 is connected downstream of the LEDs in contrast to the arrangement shown in FIG. 5a in which it is upstream of the LEDs 2; i.e. the shunt 25 is connected between the LEDs 2 and ground 30 since protection of the shunt 25 in the event of a short circuit at the output in the case of the present light source 1 is not required. A schematic block circuit diagram of a variant of the light source 1 shown in FIG. 5a is illustrated in FIG. 6a. Instead of a plurality of external control and diagnostic connections 26, 27, 28, the corresponding inputs or outputs of the current controller 24 of the converter unit 5 are connected to a separate logic module 16. The logic module 16 is preferably programmable and implements a bus protocol for serial communication via a single-wire or in particular an LIN interface 15. The logic module 16 can be supplied power via the same voltage as the current controller 24. In this variant, the light source 1 manages with only three connections 14, 15.

In the case of the light source 1 illustrated in FIG. 6a, it would likewise be conceivable to omit the binning coding resistor 29 and to store the binning of the LEDs 2 over the course of manufacture in the logic module 16, for example, and to transmit said binning during operation from the logic module 16 to the current controller 24 via a further interface. This would have the advantage, for example, that the binning would be independent of humidity and independent of temperature and could be set at less cost.

In a manner comparable with FIG. 5b, in FIG. 6b the shunt 25 for measuring the string current is connected downstream of the LEDs 2, in contrast to the circuit shown in FIG. 6a, or connected in series with the LEDs 2 and between the LEDs 2 and ground 30 in a “lowside” arrangement, which considerably simplifies the circuit in practice and makes the production of said circuit more economical.

1-14. (canceled)

15. A light source for integration into a headlamp, the light source comprising:
a printed circuit board having an upper side;
at least one light-emitting diode disposed on said upper side of said printed circuit board, said at least one LED being a surface-mounted component;
a converter unit for supplying power to said LED, said converter unit being a surface-mounted component disposed on said upper side of said printed circuit board;
said converter unit having a plurality of step-down converters configured to provide a supply voltage of said at least one LED having a value identical to, or less than, a supply voltage of said converter unit; and
said converter unit being formed as a system-in-package integration set.

16. The light source according to claim 15, wherein said at least one LED is one LED of a parallel circuit of a plurality of LEDs disposed on said printed circuit board and connected to said converter unit.

17. The light source according to claim 15, wherein said printed circuit board is a thermal substrate.

18. The light source according to claim 17, wherein said printed circuit board is a metal-core printed circuit board.

19. The light source according to claim 18, wherein said metal-core printed circuit board has an aluminum core or copper core.

20. The light source according to claim 15, which further comprises a cooling device connected to a back side of said printed circuit board opposite said at least one LED.

21. The light source according to claim 20, wherein said cooling device is a cooling plate or a die-cast body.

22. The light source according to claim 20, wherein said cooling device is welded to the back side of said printed circuit board.

23. The light source according to claim 20, wherein said cooling device consists of a same material as a metal core of said printed circuit board.

24. The light source according to claim 15, wherein said converter unit is connected to an interface for transmitting diagnostic data and/or control data.

25. The light source according to claim 24, wherein said interface is a single-wire interface.

26. The light source according to claim 24, wherein said interface is a local interconnect network interface.

27. The light source according to claim 15, which comprises a binning coding element disposed together with said converter unit and said at least one LED on said printed circuit board.

28. The light source according to claim 27, wherein said binning coding element is a binning coding resistor.

29. The light source according to claim 15, which further comprises a shunt for measuring an LED current connected in series with said at least one LED.

30. The light source according to claim 29, wherein said shunt is connected between said at least one LED and ground.
